(19) United States
(12) Patent Application Publication
(10) Pub. No.: US 2003/0127972 A1
(43) Pub. Date: Jul. 10, 2003

(54) Dual-panel active matrix organic electroluminscent display

(76) Inventors: Cheng-Xian Han, Kaohsiung City (TW); Heng-Long Yang, Taipei City (TW); Feng-Yu Chuang, Hsinchu City (TW); Yung-Hui Yeh, Hsinchu City (TW); Yuan-Chang Huang, Hsinchu (TW)

Correspondence Address: SUPREME PATENT SERVICES, POST OFFICE BOX 2339, SARATOGA, CA, 95070, US

(21) Appl. No.: 10/040,560

(22) Filed: Jan. 5, 2002

(51) Int. Cl. H05B 33/00; H01J 63/04

(52) U.S. Cl. 313/504

(57) ABSTRACT

A dual-panel active matrix organic electroluminescent display comprises an organic electroluminescent display panel, an active matrix panel, and a conducting and adhesive material between these two panels. The organic electroluminescent display panel and the active matrix panel are fabricated separately and then adhered and bonded together. Therefore, the layout portion of a polycrystalline-silicon TFT can be increased. If a heat and pressure adhering method is used to bond the two panels, a transparent light-conducting region is not required for the pixels on the active matrix panel. If a UV light exposure adhering method is used, only a small transparent region is reserved for UV light curing. As a result, the lighting area of the organic electroluminescent display is almost 100%.

### FIELD OF THE INVENTION

The present invention relates generally to an organic electroluminescent display, and more specifically to a full color active matrix organic electroluminescent display with a dual panel structure.

### BACKGROUND OF THE INVENTION

Flat-panel displays (FPD) have become one of the most important electronic products. They are widely used as display devices for notebooks, personal computers, electronic equipment and televisions. Among the flat-panel displays, organic electroluminescent (OEL) displays have emerged as the display of choice in the market place because of their following advantages: light emitting, high luminous efficiency, wide viewing angle, fast response speed, high reliability, full color, low driving voltage, low power consumption and simple fabrication process.

Although the manufacturing process of a conventional passive organic electroluminescent display device is simple and the manufacturing cost is inexpensive, its resolution is not high. It can only be used to make small size, and low-resolution display devices. An active matrix organic electroluminescent display device, using thin-film-transistors (TFT) in an active-addressing scheme, has features of high resolution, high luminous efficiency and low power consumption. Generally speaking, an active drive scheme is the main stream for high-resolution driving technologies. As the size of a display becomes bigger, the resolution becomes higher and the display colors become richer, a full color active matrix organic electroluminescent display is necessary to meet the requirements.

U.S. Pat. No. 5,550,066 discloses a manufacturing process for making a pixel structure of a thin-film-transistor organic emitting light display device. FIG. 1a and FIG. 1b show respectively a diagrammatic plan view and a cross-sectional view of this conventional TFT organic emitting light display device. As shown in FIG. 1a, the pixel structure of a TFT organic emitting light display device 100 comprises mainly two thin film transistors 101 and 102, a storage capacitor 103, and a light emitting OEL pad 104 arranged on a substrate. The TFT 101 is the logic transistor with the source bus 105 as the data line and the gate bus 106 as the gate line.

The ground bus 107 is located above the gate bus 106 and below the storage capacitor 103. The source electrode of the TFT 101 is electrically connected to the source bus 105 and the gate electrode is formed by a portion of the gate bus 106. The OEL pad 104 is electrically connected to the drain electrode of the TFT 102. The drain electrode of the TFT 101 is electrically connected to the gate electrode of the TFT 102, which in turn is electrically connected to the storage capacitor 103. A TFT organic emitting light display device comprises a plurality of pixels with TFT organic emitting light structures.

FIG. 1b is a cross-sectional view illustrating the process of forming a pixel structure of this conventional TFT organic emitting light display device. As shown in FIG. 1b, a polysilicon layer is deposited over a transparent insulating substrate 111 and the polysilicon layer is patterned into a polysilicon island 118. Next, a first insulating gate layer 112 is deposited over the polysilicon island 118. A layer of silicon 114 is deposited over the insulating gate layer 112 and patterned by photolithography over the polysilicon island 118 in such a way that after ion implantation, source and drain regions are formed in the polysilicon island 118. Ion implantation is conducted with N-type dopants.

A gate bus 116 is applied and patterned on the insulating gate layer 112, and then a second insulating layer 113 is applied over the entire surface of the device. Two contact holes are cut in the second insulating layer 113 and electrode materials are applied to form contacts with the thin-film-transistors. The electrode material attached to the source region of TFT 102 also forms the top electrode 122 of the storage capacitor 103. A source bus and a ground bus are also formed over the second insulating layer 113. In contact with the drain region of TFT 102 is the anode 136 for the OEL material. An insulating passivation layer 124 is deposited over the surface of the device. The OEL layer 132 is then deposited over the passivation layer 124 and the anode layer 136. The passivation layer 124 is etched, leaving a tapered edge to increase the viscosity with the OEL layer 132. Finally, a cathode electrode layer 134 is deposited over the surface of the device.

The structure of a conventional active drive organic electroluminescent display device is usually made by two methods. The first method uses a source-follow-p-channel TFT and a normal type organic electroluminescent structure to form the electroluminescent layer and the TFT array on the same substrate. In this method, light is transmitted through the TFT substrate. The layout portion of the active matrix is therefore dark. Usually, the aperture ratio of the TFT array is as low as 10-30%. As a result, it is difficult to increase the resolution of the display device. The second method uses a source-follow-n-channel TFT and an inverted type organic electroluminescent structure. However, the manufacturing technology of the inverted type organic electroluminescent structure is not as mature as that of the normal type organic electroluminescent structure and the luminous efficiency of the normal type organic electroluminescent structure is one to two orders higher than that of the inverted type organic electroluminescent structure. Therefore, the feasibility of the second method is not high.

Another obstacle in the technology is that it is difficult to show gray levels if a polycrystalline-silicon TFT process is used to form active drive organic electroluminescent display devices because of the variation of the threshold voltage of the polycrystalline-silicon TFT. Therefore, in order to gain acceptance by the market of flat-panel displays, active drive organic electroluminescent display devices must overcome the above-mentioned drawbacks and increase the luminous efficiency.

### SUMMARY OF THE INVENTION

This invention has been made to overcome the drawbacks of the conventional organic electroluminescent display. The primary object is to provide an active matrix organic electroluminescent display with a dual panel structure. The organic electroluminescent display comprises an upper organic electroluminescent display panel, a lower active matrix panel, and a conducting and adhesive material filling the gap between these two panels to adhere them together.

In the preferred embodiment of the invention, the upper organic electroluminescent display panel comprises a transparent substrate, a layer of ITO deposited on the top surface of the substrate, a patterned OEL film formed on the ITO layer, a cathode layer deposited on the OEL film and a covering passivation layer. The top of the cathode layer has an opening formed as the contact window to the lower active matrix panel.

In the preferred embodiment, the lower active matrix panel is a TFT panel. A single pixel in the TFT panel comprises at least one metal scan bus line, at least one metal data bus line, and an active matrix layout portion. A contact region must be included in the pixel for adhering to and conducting with the upper panel.

Accordingly, the conducting and adhesive material bonds the two panels together with pixel-to-pixel alignment. Because the conducting and adhesive material is anisotropic conductive, it is conductive only in the portion of upper and lower electrodes. It is not conductive in the lateral direction.

Another object of the present invention is to provide a manufacturing method for the dual-panel active matrix organic electroluminescent display device. The manufacturing method comprises the fabrication of the organic electroluminescent display panel, the fabrication of the active matrix panel, and the adhering method that bonds the two panels together.

According to the present invention, the two panels of the dual panel active matrix organic electroluminescent display device can be fabricated separately. Pixels on the active matrix panel either do not require a transparent light-conducting region or only need a small transparent region reserved for UV light curing. Therefore, the lighting area of the organic electroluminescent display of the invention is almost 100%.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a diagrammatic plan view of a conventional TFT organic emitting light display device.

FIG. 1b is a cross-sectional view of FIG. 1, illustrating the process of forming a pixel structure of a conventional TFT organic emitting light display device.

FIG. 2 is a schematic plan view of a dual panel active matrix organic electroluminescent display according to the present invention.

FIGS. 3a-3d are sectional views illustrating steps of fabricating the upper organic electroluminescent display panel according to the present invention.

FIG. 4 is a cross-sectional view of the upper panel manufactured by the steps of FIG. 3.

FIG. 5 illustrates a diagrammatic view of a single pixel on a lower active matrix panel according to the present invention.

FIGS. 6a and 6b illustrate a single pixel on a lower active matrix panel shown in FIG. 5, wherein FIG. 6a is a schematic cross-sectional view and FIG. 6b is a simplified view of FIG. 6a.

FIG. 7a illustrates a diagrammatic view after bonding the two panels shown in FIG. 4 and FIG. 6b respectively.

FIG. 7b illustrates a diagrammatic view of the three pixels of red, green, and blue colors after the upper and lower panels are adhered together.

FIG. 8a illustrates an adhering method that applies hot air on the surface of the upper transparent panel and the surface of the lower glass panel and uses a metal bump of low melting point as the conducting and adhesive material.

FIG. 8b illustrates another adhering method that adds pressure to the heater placed on the surface of the upper transparent panel, exposes the surface of the lower glass panel to a UV light, and uses a UV light curable anisotropic conductive adhesive as the conducting and adhesive material.

FIG. 8c illustrates another adhering method that applies heat and pressure to the heater placed on the surface of the upper transparent panel and uses an anisotropic conductive film as the conducting and adhesive material.

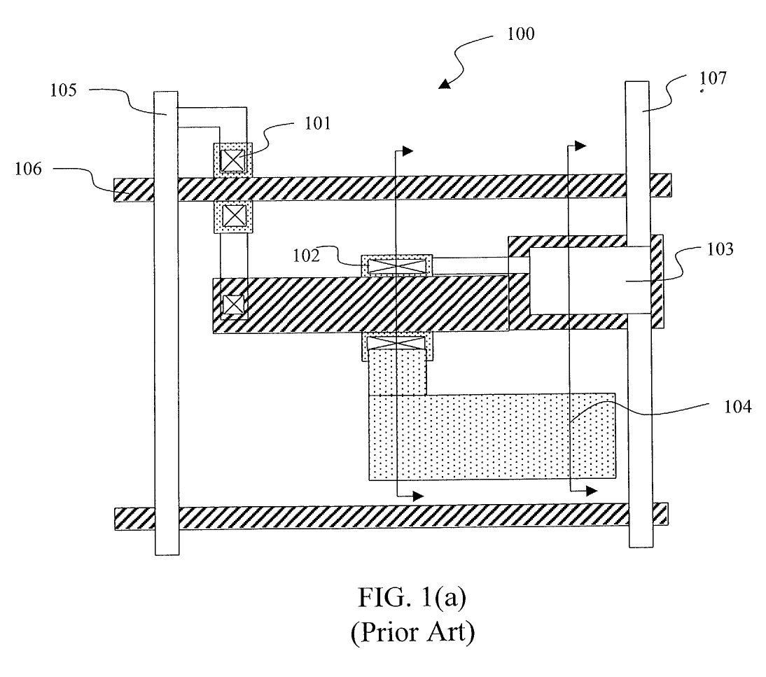

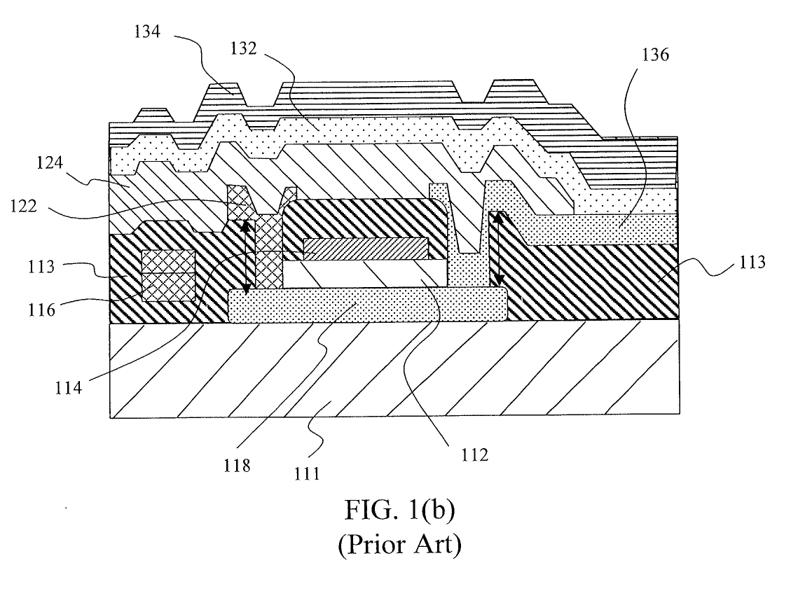

### DETAILED DESCRIPTION OF THE INVENTION

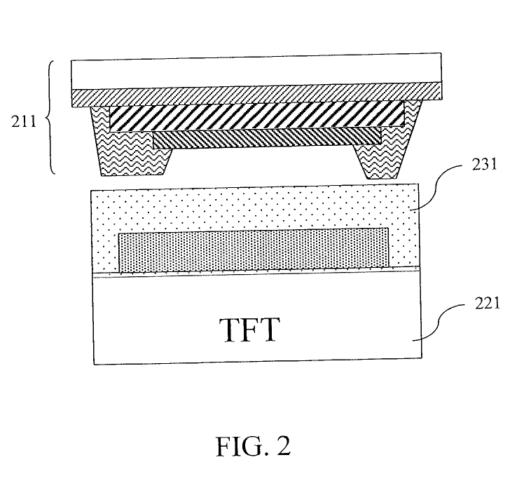

FIG. 2 is a schematic plan view of a preferred embodiment of a dual-panel active matrix organic electroluminescent display according to the present invention. The dual-panel active matrix organic electroluminescent display comprises two panels and a conducting and adhesive material filling the gap between the two panels to adhere them together. Referring to FIG. 2, one panel is a full color or monochrome organic electroluminescent substrate 211, called the upper panel. Its structure can be a normal or inverted type structure. The OEL material can be chosen from the high or small molecule series, and the panel material can be glass or plastic. Another panel is an active matrix substrate 221, called the lower panel. It can be a polycrystalline-silicon (poly-Si) or an amorphous-silicon (a-Si) TFT substrate. The conducting and adhesive material 231 that bonds these two panels can be an anisotropic conductive film (ACF), an anisotropic conductive adhesive (ACA), a conducting resin, an Ag epoxy or a metal bump. A UV exposure method or a thermal curing method is used to bond the two panels. The preferred resistance of the conducting and adhesive material is in the range between 0.1 and 10⁶ ohms.

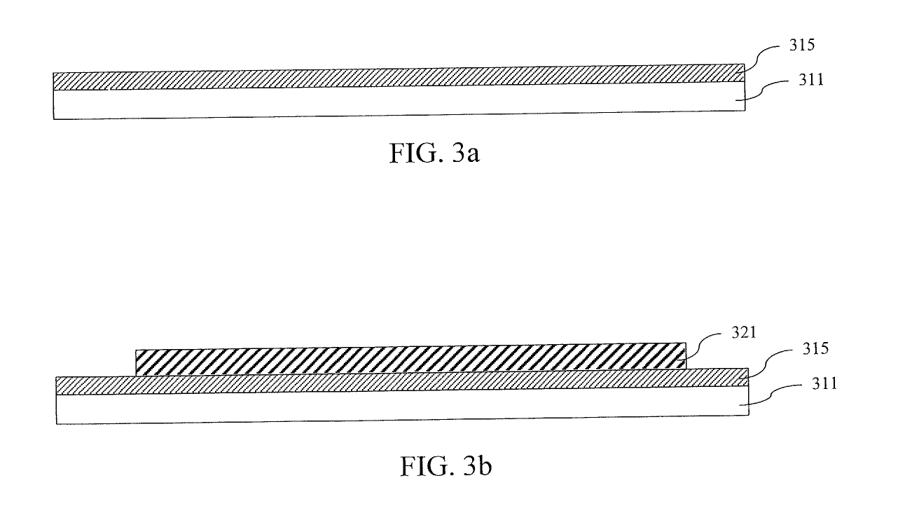

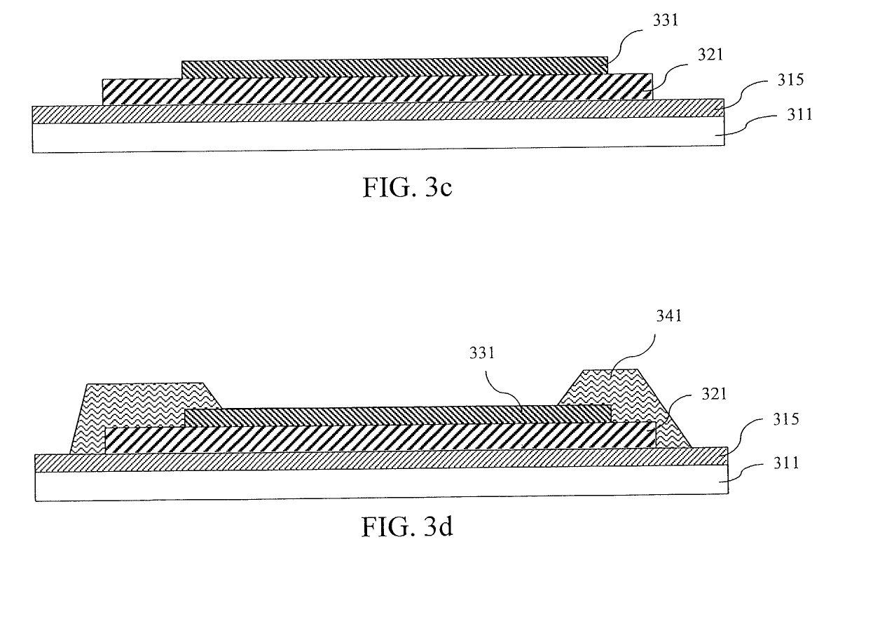

The followings describe the manufacturing process and show the cross-sectional views of a dual-panel active matrix organic electroluminescent display device of the invention. FIGS. 3a-3d are sectional views illustrating the steps of fabricating the upper organic electroluminescent display panel according to the present invention. At first, a layer of transparent material 315, such as ITO, is deposited on the top surface of a substrate 311 having top and bottom surfaces, as shown in FIG. 3a. Referring to FIG. 3b, a patterned OEL film 321 is deposited by a shadow mask method if organic light-emitting diodes of small molecules are used, or by an inkjet printing method if organic light-emitting diodes of high molecules are used.

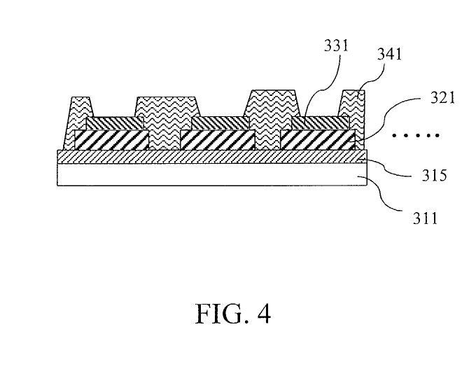

The OEL film can be an electron hole transmission layer, an electron transmission layer, or an organic light layer (OLL). A cathode layer 331 is then deposited as shown in FIG. 3c. The cathode layer 331 is made of a metal such as aluminum (Al). Finally, a passivation layer 341 is formed as shown in FIG. 3d. The passivation layer 341 is used as the insulation between pixels to protect the OEL film 321 from being damaged by water and oxygen. It is worth mentioning that an opening on the top of the cathode layer 331 must be formed as the contact window to the lower active matrix panel. FIG. 4 is a cross-sectional view of the upper panel manufactured by the processes of FIG. 3.

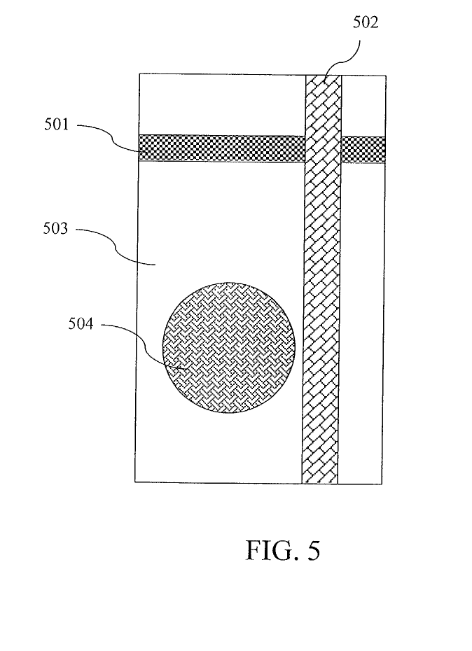

FIG. 5 shows a diagrammatic view of a single pixel on the lower active matrix panel according to the present invention. A single pixel comprises at least one metal scan bus line 501, at least one metal data bus line 502, and an active matrix layout portion 503. A contact region 504 must be included in the pixel to adhere to and conduct with the upper panel.

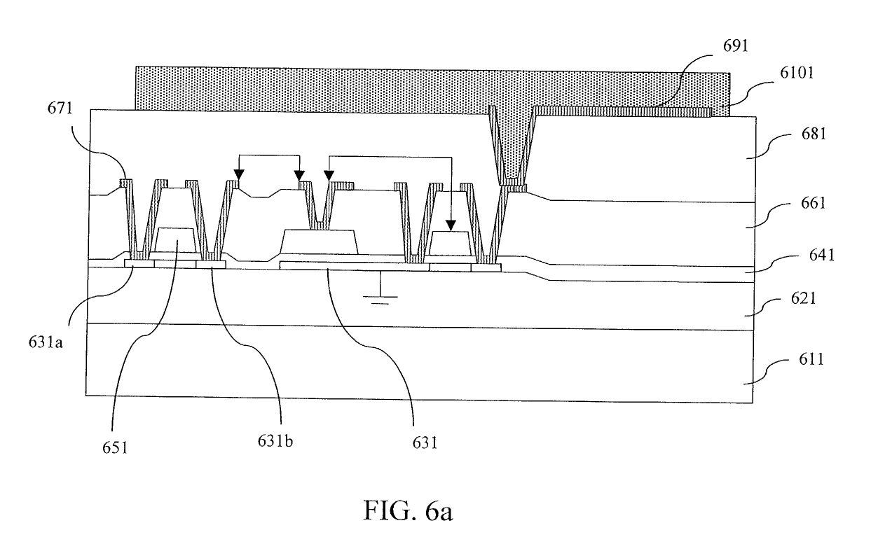

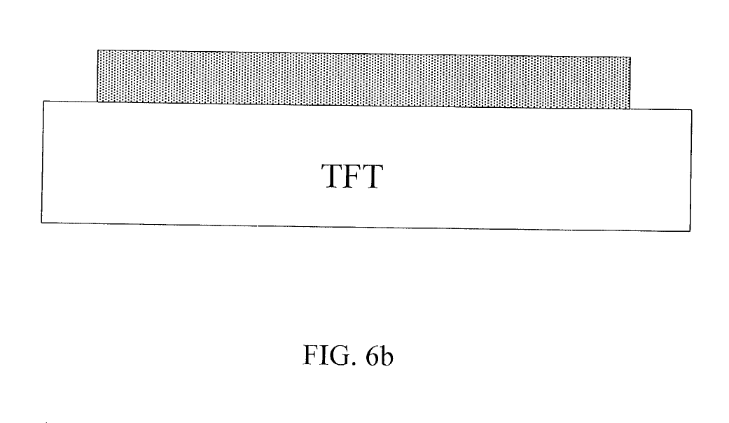

In the preferred embodiment of the invention, the lower active matrix panel is a TFT panel. It can be a polycrystalline-silicon or an amorphous-silicon TFT substrate. The design of its structure is well known to those of ordinary skill in the art. FIG. 6a illustrates a schematic cross-sectional view of the single pixel on the lower active matrix panel shown in FIG. 5. Referring to FIG. 6a, the manufacturing process is described briefly as follows: (a) forming a buffer layer 621 on a glass substrate 611; (b) depositing a polycrystalline-silicon or amorphous-silicon layer 631 on the buffer layer 621 to define a source region 631a and a drain region 631b of a TFT; (c) defining and forming a polycrystalline-silicon island 641 by a laser crystallization and etching method; (d) depositing electrode materials over the polycrystalline-silicon island 641 to form a gate layer 651; (e) depositing an interlayer 661 above the gate layer 651 and the polycrystalline-silicon island 641; then (f) etching out contact holes and covering a metal layer 671 on the interlayer 661; (g) covering a passivation layer 681 of photo or non-photo resist material on the metal layer 671; (h) etching a portion of the passivation layer 681 after exposure and development in a standard photolithography process using a photo mask pattern and coating a layer of color filter of photo resist on the interlayer 661 to define a color filter 691; and (i) finally depositing a layer 6101 of transparent material such as indium-tin-oxide (ITO), over the passivation layer 681, the color filter 691 and the whole surface of the device. The transparent layer 6101 is defined as an anode layer and is electrically connected to the drain electrode of another TFT. FIG. 6b is a simplified view of FIG. 6a.

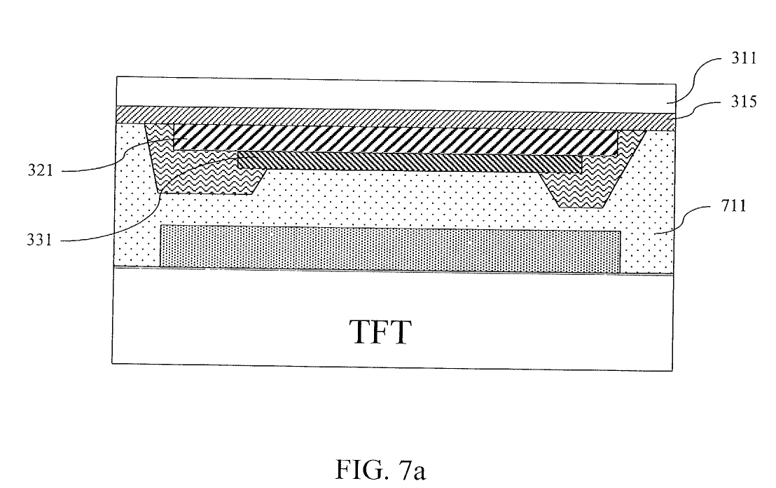

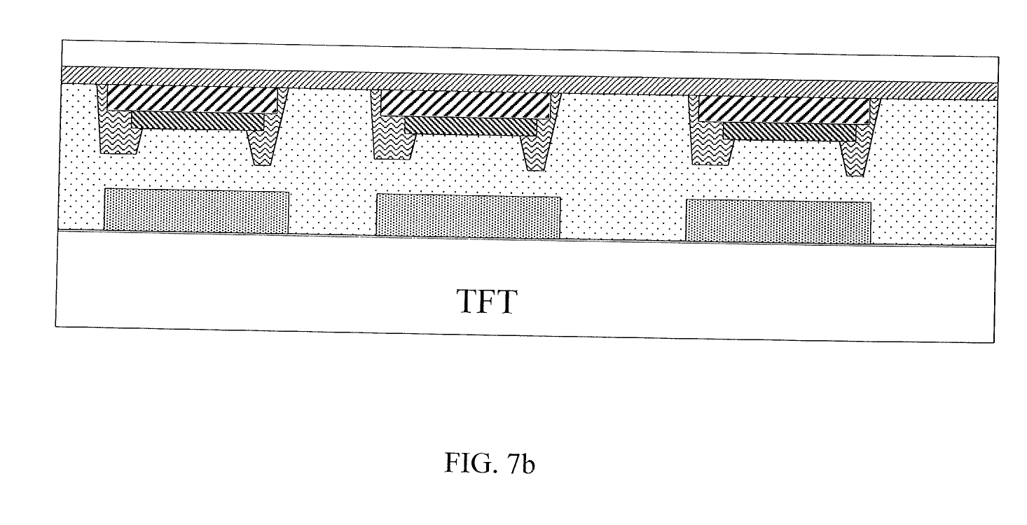

After having finished the upper and lower panels, a layer 711 of conducting and adhesive material is coated on one of the upper and lower panels. Then the two panels are adhered together with pixel-to-pixel alignment, as shown in FIG. 7a. Because the conducting and adhesive material is anisotropic conductive, similar to an ACF, it is conductive only in the portion of upper and lower electrodes. It is not conductive in the lateral direction. FIG. 7b illustrates a diagrammatic view of the three pixels for red, green, and blue colors after the upper and lower panels are adhered together.

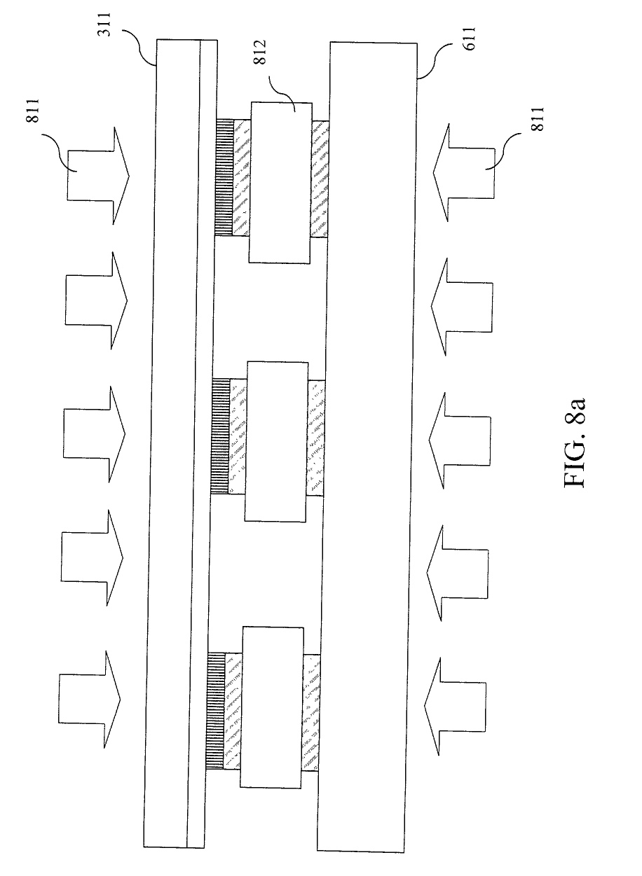

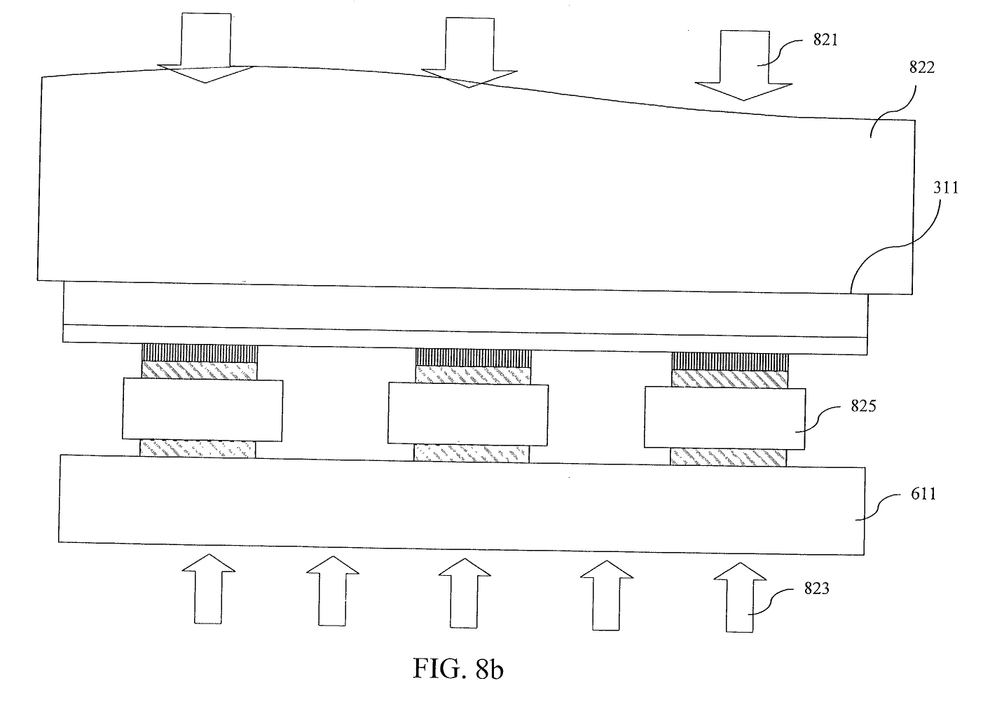

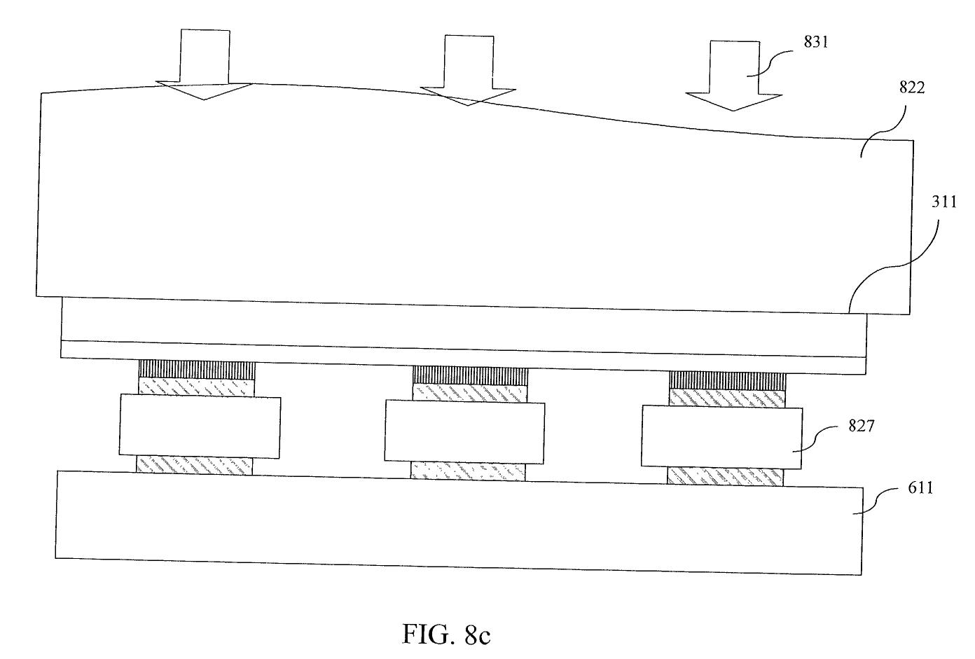

Thermal curing and exposure to UV light are preferred methods for adhering and bonding the two panels. The conducting and adhesive material is chosen according to the adhering method thereof. FIG. 8a shows an adhering method that applies hot air 811 on the surface of the upper transparent panel 311 and the surface of the lower glass panel 611, wherein a metal bump 812 of low melting point is used as the conducting and adhesive material. FIG. 8b shows another adhering method that adds pressure 821 to the heater 822 placed on the surface of the upper transparent panel 311 and exposes the surface of the lower glass panel 611 to the UV light 823, wherein a UV light curable anisotropic conductive adhesive 825 is used as the conducting and adhesive material. FIG. 8c shows another adhering method that applies heat and pressure 831 to the heater 822 placed on the surface of the upper transparent panel 311, wherein an anisotropic conductive film 827 is used as the conducting and adhesive material. The preferred resistance of the conducting and adhesive material is in the range between 0.1 and 10⁶ ohms.

When the heat and pressure method is used, it does not require a transparent light-conducting region for the pixels on the lower panel. If the UV light exposure method is used, only a small transparent region is reserved for UV light curing. Therefore, the lighting area of the organic electroluminescent display of the invention is almost 100%.

Because the electroluminescent layer and the TFT array are fabricated on different substrates, light can pass through the OEL substrate and the layout portion of the polycrystalline-silicon TFT can be increased. Therefore, the issue of light non-uniformity is resolved. The light non-uniformity issue can also be resolved by using amorphous-silicon source-follow-n-channel TFTs. The resolution of the display device can also be increased. In addition, the volume of production and the yield rate are also increased because of the separate fabrication of the substrates.

Therefore, the full color active matrix organic electroluminescent display with a dual-panel structure of the invention has been made to overcome the drawbacks of the conventional organic electroluminescent display. Its advantages include simple fabrication process, high resolution, high luminous efficiency, high volume of production and high yield rate.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A dual-panel active matrix organic electroluminescent display, comprising:
an organic electroluminescent display panel;
an active matrix panel; and
a conducting and adhesive material between said two panels.

2. The dual-panel active matrix organic electroluminescent display as claimed in claim 1, said active matrix panel being a thin-film-transistor panel.

3. The dual-panel active matrix organic electroluminescent display as claimed in claim 2, said active matrix panel being a polycrystalline-silicon or an amorphous-silicon thin-film-transistor panel.

4. The dual-panel active matrix organic electroluminescent display as claimed in claim 2, wherein each single pixel on said thin-film-transistor panel has at least one scan bus line, at least one data bus line, an active matrix layout portion, and a contact region for adhering to and conducting with said organic electroluminescent display panel.

5. The dual-panel active matrix organic electroluminescent display as claimed in claim 1, wherein said conducting and adhesive material is chosen from the group of an anisotropic conductive film, an anisotropic conductive adhesive, a conducting resin, an Ag epoxy, and a metal bump.

6. The dual-panel active matrix organic electroluminescent display as claimed in claim 1, wherein said conducting and adhesive material has resistance in a range between 0.1 and 10⁶ ohms.

7. The dual-panel active matrix organic electroluminescent display as claimed in claim 1, wherein said organic electroluminescent display panel further comprising:
a transparent substrate having top and bottom surfaces;
a layer of transparent material deposited on the top surface of said transparent substrate;
a patterned organic electroluminescent film deposited on said layer of transparent material;
a cathode layer deposited on said patterned organic electroluminescent film; and
a passivation layer formed on said cathode layer for protecting said patterned organic electroluminescent film from being damaged by water and oxygen;
wherein an opening is formed on the top of said cathode layer as a contact window to said active matrix panel.

8. The dual-panel active matrix organic electroluminescent display as claimed in claim 7, said organic electroluminescent film being an electron hole transmission layer, a electron transmission layer, or an organic light layer.

9. A method for manufacturing a dual-panel active matrix organic electroluminescent display, comprising the steps of:
fabricating an organic electroluminescent display panel;
fabricating an active matrix panel;
disposing a conducting and adhesive material between said organic electroluminescent display panel and said active matrix panel; and
adhering and bonding said two panels together.

10. The method for manufacturing a dual-panel active matrix organic electroluminescent display as claimed in claim 9, said conducting and adhesive material being deposited on said active matrix panel to bond said two panels together with pixel-to-pixel alignment.

11. The method for manufacturing a dual-panel active matrix organic electroluminescent display as claimed in claim 9, wherein the step of adhering and bonding said two panels comprises a UV exposure method or a thermal curing method.

12. The method for manufacturing a dual-panel active matrix organic electroluminescent display as claimed in claim 9, wherein a UV light curable anisotropic conductive adhesive is used as the conducting and adhesive material, and the step of adhering and bonding said two panels comprises placing a heater on a surface of said organic electroluminescent display panel, adding pressure to said heater, and exposing a surface of said active matrix panel to a UV light.

13. The method for manufacturing a dual-panel active matrix organic electroluminescent display as claimed in claim 9, wherein a metal bump of low melting point is used as the conducting and adhesive material, and the step of adhering and bonding said two panels comprises applying hot air on a surface of said organic electroluminescent display panel and a surface of said active matrix panel.

14. The method for manufacturing a dual-panel active matrix organic electroluminescent display as claimed in claim 9, wherein an anisotropic conductive film is used as the conducting and adhesive material, and the step of adhering and bonding said two panels comprises placing a heater on a surface of said organic electroluminescent display panel, and applying heat and pressure to said heater.

15. The method for manufacturing a dual-panel active matrix organic electroluminescent display as claimed in claim 9, wherein fabricating said organic electroluminescent display panel further comprises the steps of:
(a) preparing a transparent substrate having top and bottom surfaces;
(b) depositing a layer of transparent material on the top surface of said transparent substrate;
(c) depositing a patterned organic electroluminescent film on said layer of transparent material;
(d) depositing a cathode layer on said patterned organic electroluminescent film; and
(e) forming a passivation layer on said cathode layer for protecting said patterned organic electroluminescent film from being damaged by water and oxygen;
wherein an opening is formed on the top of said cathode layer as a contact window to said active matrix panel.

16. The method for manufacturing a dual-panel active matrix organic electroluminescent display as claimed in claim 15, said organic electroluminescent film being deposited by a shadow mask method using organic light-emitting diodes of small molecules.

17. The method for manufacturing a dual-panel active matrix organic electroluminescent display as claimed in claim 15, said organic electroluminescent film being deposited by an inkjet printing method using organic light-emitting diodes of high molecules.

18. The method for manufacturing a dual-panel active matrix organic electroluminescent display as claimed in claim 15, wherein said conducting and adhesive material is deposited over said passivation layer on said organic electroluminescent display panel to bond said two panels together with pixel-to-pixel alignment.
